(19) United States
(12) Patent Application Publication
(10) Pub. No.: US 2024/0377426 A1
(43) Pub. Date: Nov. 14, 2024

(54) SYSTEM AND METHOD FOR MONITORING THE SPEED OF AN INSPECTION UNIT OF A SEWER INSPECTION AND/OR MAINTENANCE SYSTEM

(71) Applicant: iPEK International GmbH, Sulzberg (DE)

(72) Inventors: Fabrizio TOZZO, Wolfertschwenden (DE); Rajeesh KUMAR, Kempten (DE); Muhammad TALHA, Durach (DE)

(21) Appl. No.: 18/658,611

(22) Filed: May 8, 2024

(30) Foreign Application Priority Data
May 9, 2023 (DE) 10 2023 112 066.2

(51) Int. Cl. G01P 1/10

(52) U.S. Cl. CPC G01P 1/103

(57) ABSTRACT

A method for monitoring the speed of an inspection unit of a sewer inspection or maintenance system is provided where the inspection unit is movable in a sewer. The method includes a first step in which a driving speed of the inspection unit is detected, a second step in which the detected driving speed is compared with a predetermined driving speed, where a speed indicator is generated based upon the result of the comparison, a third step in which, based upon the generated speed indicator, a colored symbol is selected from a set of colored symbols, and a fourth step in which the selected colored symbol is displayed on a display device. The speed indicator indicates within which speed interval from a set of predetermined speed intervals the detected driving speed falls.

### CROSS REFERENCE TO RELATED APPLICATIONS

This application claims priority to German Patent Application No. 10 2023 112 066.2, filed May 9, 2023, the contents of which are incorporated by reference herein.

### FIELD OF THE INVENTION

The invention relates to a system and method for monitoring the speed of an inspection unit of a sewer inspection and/or maintenance system.

### BACKGROUND OF THE INVENTION

In sewer inspection and/or maintenance systems, image recording devices (cameras or video cameras) are used to record the interior of a pipe or sewer. When carrying out inspections, in particular visual inspections of a sewer, certain specifications or conditions must usually be observed. For example, official regulations may stipulate that certain speeds may not be exceeded during a visual inspection when recording the inventory and condition of wastewater systems.

In the prior art, it is common practice to display the current driving speed, e.g., of a crawler in a sewer, on a display device—for example, as meters per second. This allows the operator of an inspection system to see the current driving speed. However, the operator must constantly monitor the displayed driving speed to avoid exceeding the maximum speed. In addition, the operator must know what the current maximum speed is. The maximum speed applicable for an inspection can depend upon the inspection unit used and upon the type of inspection carried out. For example, a video inspection may allow a maximum speed of 15 cm/s, while an ultrasonic inspection may allow only a maximum speed of 10 cm/s. For video inspections, the maximum permissible speed may depend upon the resolution of the camera used or the frame rate used.

### Object of the Invention

The object of the invention is therefore to provide solutions that enable simpler and safer monitoring of driving speeds of inspection units (such as a crawler) of a sewer inspection and/or maintenance system.

### Solution According to the Invention

This object is achieved by a method and a system according to the independent claims. Advantageous embodiments are specified in the respective dependent claims.

Accordingly, a method is provided for monitoring the speed of an inspection unit of a sewer inspection and/or maintenance system which is movable in a sewer, wherein the method comprises at least:
a first step S1 in which a driving speed of the inspection unit is detected,
a second step S2 in which the detected driving speed is compared with at least one predetermined driving speed, wherein a speed indicator is generated based upon the result of the comparison,
a third step S3 in which, based upon the generated speed indicator, a colored symbol is selected from a set of colored symbols, and
a fourth step S3 in which the selected colored symbol is displayed on a display device,
   wherein the speed indicator indicates within which speed interval from a set of predetermined speed intervals the detected driving speed falls.

The advantage here is that the operator no longer has to monitor any specific speed values. Using the colored symbol displayed on the display device, the operator can see at a glance whether the current driving speed is within a permissible speed range, i.e., whether the current driving speed is below or above a certain maximum speed.

The at least one predetermined driving speed can be an interval from the set of predetermined speed intervals, wherein, in the second step, a comparison is made as to within which speed interval the detected driving speed falls.

This makes it easy to signal to the user on the display device within which speed interval the current driving speed falls. Examples of speed intervals are approximately 0 to 5 cm/s (normal speed-visualized by a green symbol), 5 cm/s to 10 cm/s (increased, but permissible speed-visualized by a yellow symbol), and more than 10 cm/s (increased, non-permissible speed-visualized by a red symbol).

The set of predetermined speed intervals can be determined as a function of the inspection unit used, wherein the set of predetermined speed intervals is redetermined for this inspection unit when the inspection unit is changed. This means that the number of speed intervals and the limits of each interval are determined as a function of the inspection unit used. For example, for a first inspection unit, a first speed interval may have interval limits of 0 cm/s and 5 cm/s, and, for a first inspection unit, a first speed interval may have interval limits of 0 cm/s and 10 cm/s. In a processing device of a sewer inspection and/or maintenance system, the intervals and interval limits can be stored for different inspection units and for different types of inspections. The processing device is then informed which inspection unit is being used or which type of inspection is being carried out. The processing device can then independently determine the respective intervals and, based upon the determined intervals, determine the speed indicator for the detected driving speed.

In one embodiment of the invention, the speed indicator can assume at least a first value and a second value, wherein
the first value indicates that the detected driving speed does not exceed a predetermined maximum driving speed, and
the second value indicates that the detected driving speed exceeds the predetermined maximum driving speed.

It is advantageous if the driving speed of the inspection unit is continuously detected, wherein the second step, the third step, and the fourth step are continuously carried out based upon the continuously detected driving speed in order to update the colored symbol displayed on the display device when the speed indicator changes.

In an advantageous embodiment of the invention, it can be provided that the display device have a vibration device, wherein, when the driving speed approaches the maximum speed or when the maximum speed is exceeded, the vibration device is activated in order to give the operator of the display device haptic feedback.

The invention further provides a sewer inspection and/or maintenance system comprising at least:
an inspection unit which is movable in a sewer, wherein the inspection unit has a speed measuring device which is adapted to detect a driving speed of the inspection unit,
a processing device which is coupled to the speed measuring device and which is adapted to compare the driving speed detected by the speed measuring device with at least one predetermined driving speed and to generate a speed indicator based upon the result of the comparison,
a display device which is coupled to the processing device and which is adapted to
receive the speed indicator generated by the processing device,
based upon the received speed indicator, select a colored symbol from a set of colored symbols, and
display the selected colored symbol on the display device.

### BRIEF DESCRIPTION OF THE FIGURES

Further details and features of the invention as well as specific—in particular, advantageous—embodiments of the invention are apparent from the following description in conjunction with the drawings. In the figures:

FIG. 1 is a block diagram of a system according to the invention; and

FIG. 2 shows an example of a display device for monitoring the speed of an inspection unit according to the invention.

### DETAILED DESCRIPTION OF THE INVENTION

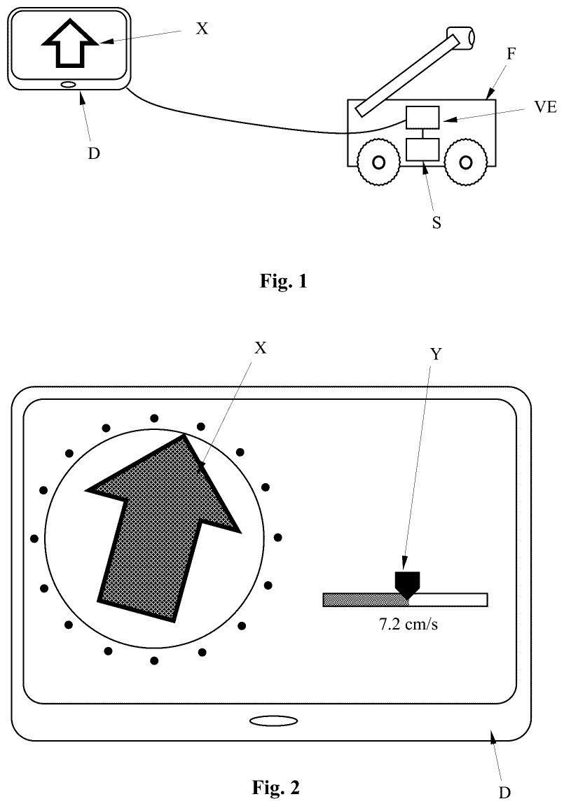

FIG. 1 is a block diagram of a system according to the invention. The inspection unit comprises a crawler F on which an inspection camera is arranged. The crawler F has a speed measuring device S which is coupled to a processing device VE. The speed measuring device is adapted to detect the driving speed of the crawler F in a sewer. Known speed measurement sensors can be used for this purpose.

The speed detected by the speed measuring device S is passed on to the processing device VE, which determines a speed indicator based upon the detected speed.

The processing device VE is coupled to a display device D. This coupling can be wireless or wired.

The speed indicator determined by the processing device VE is transmitted to the display device. The display device, based upon the received speed indicator, selects a colored symbol X from a set of colored symbols and displays the selected colored symbol. The colored symbol is particularly easy for the operator to detect. In particular, the operator can immediately see whether the speed of the crawler is within a permissible range or whether the speed of the crawler exceeds or threatens to exceed a predetermined maximum speed. The current speed value is not required for this.

### Determining the Speed Indicator:

Based upon the detected speed, the processing device VE determines a speed indicator. For this purpose, the processing device compares the detected speed with a predetermined driving speed or with predetermined intervals of driving speeds and checks into which interval the detected speed falls. Each interval is assigned a speed indicator, so that the speed indicator selected is the speed indicator that is assigned to the interval in which the current speed falls. The various intervals of driving speeds can be stored in the processing device.

### Example

Three intervals can be provided, each of which is assigned a speed indicator:
Interval 1:0 cm/s to 5 cm/s→Indicator 1
Interval 2:5 cm/s to 10 cm/s→Indicator 2
Interval 3: >10 cm/s→Indicator 3

At a detected driving speed of 7.5 cm/s, interval 2 is determined, to which speed indicator 2 is assigned.

The speed indicator may be a simple numerical value that allows the display device to select a colored symbol from a set of colored symbols.

As explained above, the intervals of driving speeds can be stored in the processing device VE.

According to the invention, it is possible that different intervals are provided for different inspection units or for different types of inspections, which intervals can also be stored in the processing device. For example, different intervals can be provided for two different camera systems, as shown in the table below.

| | Camera system 1 | Camera system 2 |
|---|---|---|
| Interval 1 | 0 cm/s to 5 cm/s | 0 cm/s to 7 cm/s |
| Interval 2 | 5 cm/s to 10 cm/s | 7 cm/s to 15 cm/s |
| Interval 3 | >10 cm/s | >15 cm/s |

If interval 3 indicates impermissible driving speeds, the corresponding speed indicator for camera system 1 would cause the display device to display a red symbol as of a speed of 10 cm/s, while, for camera system 2, a red symbol would only be displayed as of a speed of 15 cm/s.

It is advantageous if the processing device is informed which inspection unit is being used or which type of inspection is being carried out. Based upon this information, the processing device can select the corresponding intervals and use them to determine the speed indicators. In one embodiment, it can be provided that the inspection unit itself provide the processing device with the information necessary for this.

FIG. 2 shows an example of a display device for monitoring the speed of an inspection unit according to the invention.

The display device D is designed here as a tablet. An arrow is shown here as a colored symbol X used to visualize the speed indicator. However, other symbols can also be used. The color of the arrow indicates which speed indicator it is. For example, a green arrow can indicate that the driving speed is within permissible limits. A red arrow, on the other hand, can indicate that the driving speed is above a permitted maximum speed.

The inclination of the arrow can symbolize in which direction the crawler is moving.

Optionally, the current speed can also be displayed (using the Y symbol).

However, according to the invention, it is important that a colored symbol be displayed that represents a speed indicator, so that the operator of the system can determine particularly quickly whether the driving speed of the crawler is within permissible limits or not. This allows the operator to concentrate better on the actual inspection and not have to constantly monitor the current speed values.

For even greater support, the display unit can have a vibration device that is activated as soon as the driving speed approaches or exceeds the maximum speed. As the maximum speed is approached, the intensity of the vibration may increase. This means that the operator must pay attention to the symbol X at the latest as soon as he is alerted to it by vibration.

1. Method for monitoring the speed of an inspection unit of a sewer inspection and/or maintenance system which is movable in a sewer, wherein the method comprises at least:
a first step (S1) in which a driving speed of the inspection unit is detected,
a second step (S2) in which the detected driving speed is compared with at least one predetermined driving speed, wherein a speed indicator is generated based upon the result of the comparison,
a third step (S3) in which, based upon the generated speed indicator, a colored symbol is selected from a set of colored symbols, and
a fourth step (S3) in which the selected colored symbol is displayed on a display device,
wherein the speed indicator indicates within which speed interval from a set of predetermined speed intervals the detected driving speed falls.

2. Method according to claim 1, wherein the at least one predetermined driving speed is an interval from the set of predetermined speed intervals, wherein, in the second step, a comparison is made as to within which speed interval the detected driving speed falls.

3. Method according to claim 2, wherein the set of predetermined speed intervals is determined as a function of the inspection unit used, wherein the set of predetermined speed intervals is redetermined for this inspection unit when the inspection unit is changed.

4. Method according to claim 1, wherein the speed indicator can assume at least a first value and a second value, wherein
the first value indicates that the detected driving speed does not exceed a predetermined maximum driving speed, and
the second value indicates that the detected driving speed exceeds the predetermined maximum driving speed.

5. Method according to claim 1, wherein the driving speed of the inspection unit is continuously detected, and wherein the second step, the third step, and the fourth step are continuously carried out based upon the continuously detected driving speed in order to update the colored symbol displayed on the display device when the speed indicator changes.

6. Sewer inspection and/or maintenance system comprising at least:
an inspection unit (F) which is movable in a sewer, wherein the inspection unit has a speed measuring device(S) which is adapted to detect a driving speed of the inspection unit,
a processing device (VE) which is coupled to the speed measuring device and which is adapted to compare the driving speed detected by the speed measuring device with at least one predetermined driving speed and to generate a speed indicator based upon the result of the comparison, and
a display device (D) which is coupled to the processing device and which is adapted to:
receive the speed indicator generated by the processing device,
based upon the received speed indicator, select a colored symbol (X) from a set of colored symbols, and
display the selected colored symbol (X) on the display device.
